(19) United States
(12) Patent Application Publication
(10) Pub. No.: US 2011/0236765 A1
(43) Pub. Date: Sep. 29, 2011

(54) NONAQUEOUS SOLVENT, AND NONAQUEOUS ELECTROLYTE SOLUTION AND NONAQUEOUS SECONDARY BATTERY THAT USE NONAQUEOUS SOLVENT

(76) Inventors: Toru Matsui, Osaka (JP); Masato Fujikawa, Osaka (JP)

(21) Appl. No.: 13/132,503

(22) PCT Filed: Aug. 30, 2010
(86) PCT No.: PCT/JP2010/005322

§ 371 Date: Jun. 2, 2011

(30) Foreign Application Priority Data
Sep. 2, 2009 (JP) 2009-202722

(51) Int. Cl. H01M 10/056

(52) U.S. Cl. 429/330

(57) ABSTRACT

The nonaqueous solvent for a nonaqueous secondary battery of the present invention includes: a fluorinated cyclic carbonate having at least one fluorine in each designated location in the molecule; and a fluorinated phosphazene having at least one fluorine bound to a phosphorus atom in the phosphazene molecule and a ratio of the number of fluorine atoms to the number of phosphorus atoms being 4/3 or more. The fluorinated cyclic carbonate forms a good protective coat by reductive decomposition at a negative electrode, thereby improving cycle characteristics of the nonaqueous secondary battery. The fluorinated phosphazene suppresses generation of organic ions in the nonaqueous solvent, thereby reducing gas production in the nonaqueous secondary battery.

### TECHNICAL FIELD

The present invention relates to a nonaqueous solvent for use in the nonaqueous electrolyte solution of a nonaqueous secondary battery. The present invention particularly relates to an improved nonaqueous solvent containing halogenated cyclic carbonates.

### BACKGROUND ART

Conventionally, nonaqueous secondary batteries called lithium-ion batteries have been developed that use a lithium transition metal oxide for the positive electrode active material and a layered carbon compound for the negative electrode active material. Lithium cobaltate (LiCoO₂), lithium nickelate (LiNiO₂), lithium manganate (LiMn₂O₄), lithium iron phosphate (LiFePO₄) or the like is used as the lithium transition metal oxide. Artificial graphite, natural graphite or the like is used as the layered carbon compound. An electrolyte solution, gel electrolyte or polymer electrolyte comprising a dissolved lithium salt or other alkali metal salt is used as the electrolyte responsible for ion conduction between the positive and negative electrodes, and all of these electrolytes are nonaqueous.

As laptop computers, cell phones, portable gaming devices and the like become more sophisticated and highly functional, there is strong demand for nonaqueous secondary batteries with higher energy densities. In order to increase the energy density of a nonaqueous secondary battery, it is necessary to either raise the operating voltage or increase the electrical capacitance of the battery. However, doing either greatly affects the reliability of the battery. Raising the operating voltage of the battery may promote side reactions particularly at the contact surface between the nonaqueous electrolyte and a strongly oxidative positive electrode. On the other hand, increasing the electrical capacitance of the battery increases the contact time with the nonaqueous electrolyte, and a strongly reductive surface is likely to appear due to large volume changes on the negative electrode in particular, potentially leading to increased side reactions between the negative electrode and the nonaqueous electrolyte.

Side reactions between the nonaqueous electrolyte and the positive and negative electrodes are more evident when the electrolyte is a liquid, and these side reactions often take the form of gas production. Should gas be produced inside the battery, the surrounding electrical circuits may be damaged due to swelling of the battery case or leakage of liquid from the battery. Accumulation of gas between the positive and negative electrodes can lead to irregular charge-discharge reactions within the battery or render part of the battery unusable, which can change the battery charge-discharge curve or dramatically reduce the usage time. The cycle characteristics of the battery are then reduced. Side reactions can be controlled by using a gel electrolyte or polymer electrolyte as the nonaqueous electrolyte, but there is still a strong need for nonaqueous electrolyte solutions to meet the demand for high efficiency and performance in lithium-ion batteries.

Gas production and hence reduced cycle characteristics in nonaqueous secondary batteries are generally attributable to the decomposition of cyclic carbonates such as ethylene carbonate (EC) and propylene carbonate (PC) and chain carbonates such as dimethyl carbonate (DMC), ethylmethyl carbonate (EMC) and diethyl carbonate (DEC), which are used in nonaqueous electrolyte solutions. For example, carbon dioxide and the like are likely to occur when trace quantities of acidic or basic impurities are present in a nonaqueous solvent or electrolyte solution that is stored at a high temperature. The amount of gas produced increases still further when these carbonates are broken down by oxidative decomposition on the positive electrode surface or reductive decomposition on the negative electrode surface, or the decomposition products produced on each electrode surface move to the counter-electrode and participate in further reactions.

Fluorinated carbonates in which halogen atoms such as fluorine atoms are substituted for some of the hydrogen atoms in these cyclic carbonates and chain carbonates, such as fluoroethylene carbonate (FEC) and difluoroethylene carbonate (dFEC), are known to improve the cycle characteristics of nonaqueous secondary batteries (Patent Document 1).

Addition of γ-butyrolactone (γ-BL) has also been proposed as a means of suppressing gas production from nonaqueous solvents containing halogenated cyclic carbonates (Patent Document 2).

Cyclic or chain phosphazene derivatives such as hexamethoxy cyclotriphosphazene have also been proposed as nonaqueous solvents for use in combination with halogenated carbonates (Patent Document 3).

An electrolyte solution has also been proposed using a nonaqueous solvent comprising a cyclic or chain phosphazene derivative such as phenoxypentafluoro cyclotriphosphazene and a cyclic carbonate containing a C═C unsaturated bond, such as vinylene carbonate (VC) or vinylethylene carbonate (VEC), with FEC added as necessary (Patent Document 4).

Patent Document 1: Japanese Patent Application Laid-open No. 2007-19011

Patent Document 2: Japanese Patent Application Laid-open No. 2005-38722

Patent Document 3: Japanese Patent Application Laid-open No. 2006-172775

Patent Document 4: Japanese Patent Application Laid-open No. 2006-24380

### DISCLOSURE OF THE INVENTION

Halogenated cyclic carbonates such as fluorinated cyclic carbonates are desirable as nonaqueous solvents because the fluorine atoms in their structures make them resistant to oxidative decomposition on the positive electrode surface, and because they break down by reductive decomposition on the negative electrode to form protective coats that contribute to the cycle characteristics. However, they are more difficult to synthesize and therefore more expensive than ordinary organic solvents because they contain fluorine and the like. For this reason, it has been necessary to use fluorinated cyclic carbonates in mixed nonaqueous electrolyte solutions together with the nonaqueous solvents EC and DMC.

When such non-fluorinated carbonates and fluorinated cyclic carbonates are combined, however, it is thought that products from decomposition of the non-fluorinated carbonate attack the fluorinated cyclic carbonate, causing the fluorinated cyclic carbonate to decompose. As a result, it is believed that when nonaqueous electrolyte solutions using a combination of a non-fluorinated carbonate and a fluorinated cyclic carbonate are used in batteries, not only is it impossible to sufficiently control gas production in the battery, but the fluorinated cyclic carbonate is also diminished, so that adequate cycle characteristics have not been obtained.

In light of these problems, it is an object of the present invention to provide a nonaqueous solvent whereby gas production in the battery can be suppressed while exploiting the ability of the fluorinated cyclic carbonate to maintain good cycle characteristics when a nonaqueous solvent containing a fluorinated cyclic carbonate is used as the electrolyte solution of a nonaqueous secondary battery.

One aspect of the present invention is a nonaqueous solvent for a nonaqueous secondary battery, comprising: at least one fluorinated cyclic carbonate (A) selected from the group consisting of a fluorinated cyclic carbonate represented by Formula (I) below and a fluorinated cyclic carbonate represented by Formula (II) below; and a fluorinated phosphazene (B) represented by Formula (III) below:

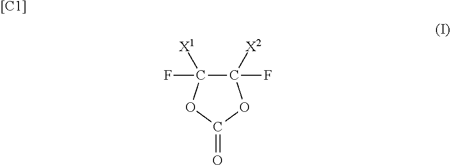

(wherein F represents fluorine, and X¹ and X² each independently represent hydrogen, fluorine or a C₁₋₄ alkyl group),

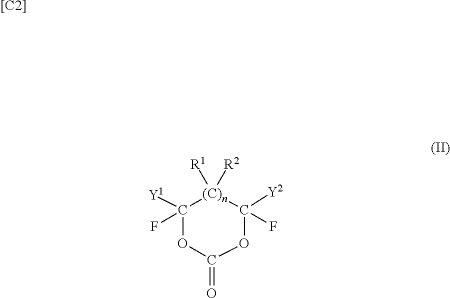

(wherein F represents fluorine, Y¹ and Y² each independently represent hydrogen, fluorine or a C₁₋₄ alkyl group, R¹ and R² each independently represent hydrogen, fluorine or a C₁₋₄ alkyl group, and n is an integer from 1 to 3),

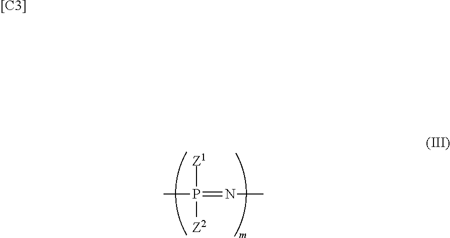

(wherein P represents phosphorus, N represents nitrogen, at least one of Z¹ and Z² represents fluorine while the other one of Z¹ and Z² independently represents hydrogen, a C₁₋₄ alkoxy group or a phenoxy group, and m is an integer from 2 to 10; a ratio of the number of fluorine atoms to the number of phosphorus atoms in Formula (III) [number of fluorine atoms/number of phosphorus atoms] is 4/3 or more; and the fluorinated phosphazene represented by Formula (III) may be either chain or cyclic).

That is, the nonaqueous solvent of the present invention contains fluorinated cyclic carbonate (A) having at least one fluorine atom in each of two specific locations in the molecule, and fluorinated phosphazene (B) having at least one fluorine atom bound to a phosphorus atom in the phosphazene molecule and a specific ratio or greater of the number of fluorine atoms to the number of phosphorus atoms.

The objects, features, aspects and advantages of the present invention will be made clearer by the following detailed descriptions and attached drawings.

### BRIEF DESCRIPTION OF THE DRAWINGS

FIG. 1 is a vertical cross-sectional view illustrating the configuration of a cylindrical nonaqueous secondary battery according to one embodiment of the present invention.

### MODE FOR CARRYING OUT THE INVENTION

According to the investigations by the inventors, in order to suppress decomposition of the fluorinated cyclic carbonate that provides good cycle characteristics of the battery as described above, it is necessary to suppress decomposition of the non-fluorinated carbonate. However, none of the existing proposals has been satisfactory.

Regarding the nonaqueous solvent proposed in Patent Document 1 for example, the investigations by the inventors have shown that gas production is not sufficiently suppressed with a nonaqueous solvent combining a fluorinated carbonate such as fluoroethylene carbonate (FEC) or difluoroethylene carbonate (dFEC) with an unsubstituted carbonate.

In the case of the nonaqueous solvent proposed in Patent Document 2, according to the investigations by the inventors, the problem is that when γ-BL is added to a nonaqueous solvent containing a fluorinated cyclic carbonate, there is a huge increase in resistance associated with movement of ions and electrons on the surface of the positive electrode, which detracts from the load characteristics of the nonaqueous secondary battery.

The investigations by the inventors have also shown with respect to the nonaqueous solvent proposed in Patent Document 3 that even using a phosphazene derivative such as the hexamethoxy cyclotriphosphazene proposed in Patent Document 3, it is difficult to suppress gas production in a battery using a nonaqueous solvent that combines an unsubstituted carbonate with a fluorinated carbonate.

Regarding the nonaqueous solvent proposed in Patent Document 4, the investigations by the inventors have shown that even using the cyclic phosphazene derivative proposed in Patent Document 4, a cyclic carbonate having a C═C unsaturated bond is liable to oxidative decomposition on the surface of the positive electrode, and existence of FEC further increases gas production in the nonaqueous secondary battery.

The present invention was achieved based on the results of these investigations. Embodiments of the present invention are explained in detail below.

[Nonaqueous Solvent]

A nonaqueous solvent of an embodiment of the present invention contains at least one fluorinated cyclic carbonate (A) selected from the group consisting of a fluorinated cyclic carbonate represented by Formula (I) below and a fluorinated cyclic carbonate represented by Formula (II) below together with a fluorinated phosphazene (B) represented by Formula (III) below:

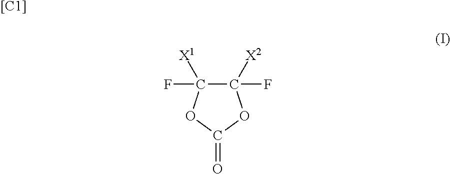

(wherein F represents fluorine, and X¹ and X² each independently represent hydrogen, fluorine or a C₁₋₄ alkyl group),

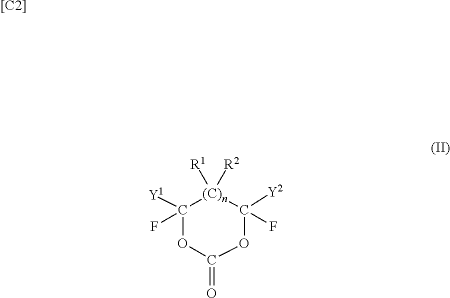

(wherein F represents fluorine, Y¹and Y² each independently represent hydrogen, fluorine or a C₁₋₄ alkyl group, R¹ and R² each independently represent hydrogen, fluorine or a C₁₋₄ alkyl group, and n is an integer from 1 to 3),

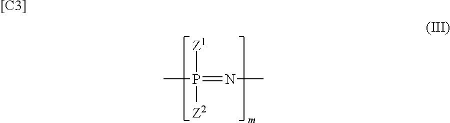

(wherein P represents phosphorus, N represents nitrogen, at least one of Z¹ and Z² represents fluorine while the other independently represents hydrogen, a C₁₄ alkoxy group or a phenoxy group, and m is an integer from 2 to 10; the ratio of the number of fluorine atoms to the number of phosphorus atoms in Formula (III) [number of fluorine atoms/number of phosphorus atoms] is 4/3 or more; and the fluorinated phosphazene represented by Formula (III) may be either chain or cyclic).

The fluorinated cyclic carbonate represented by Formula (I) is a 5-membered cyclic carbonate having a structure in which at least one fluorine atom is bound to a carbon atom of each of two alkoxy groups adjoining an oxygen atom of the carbonate. The X¹ and X² bound to the same carbon atoms are each independently hydrogen, fluorine or an alkyl group with 1 to 4 carbons. X¹ and X² are preferably each independently hydrogen, fluorine, methyl group or ethyl group. It does not matter if the combination of X¹ and X² produces a solid at room temperature as long as the product is liquid when prepared as a nonaqueous electrolyte.

In the fluorinated cyclic carbonate represented by Formula (I), the combinations shown in Table 1 below are preferred as combinations of X¹ and X².

TABLE 1

| Nonaqueous solvent | X¹ | X² |
|---|---|---|
| A | H | H |
| B | H | F |
| C | H | CH₃ |
| D | H | C₂H₅ |
| E | F | F |
| F | F | CH₃ |
| G | F | C₂H₅ |
| H | CH₃ | CH₃ |
| I | CH₃ | C₂H₅ |
| J | C₂H₅ | C₂H₅ |

Of these, the fluorinated cyclic carbonates with the combinations shown for nonaqueous solvent A and nonaqueous solvent H are preferred. These fluorinated cyclic carbonates are, respectively, the 4,5-difluoro-1,3-dioxolan-2-one(difluoroethylene carbonate) represented by Formula (IV) below and the 4,5-difluoro-4,5-dimethyl-1,3-dioxolan-2-one(difluorodimethylethylene carbonate) represented by Formula (V) below:

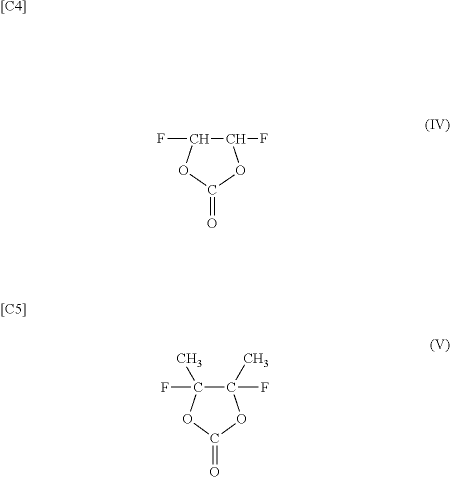

The fluorinated cyclic carbonate represented by Formula (II) is a 6-membered (n=1) to 8-membered (n=3) cyclic carbonate also having a structure in which at least one fluorine atom is bound to a carbon atom of each of two alkoxy groups adjoining an oxygen atom of the carbonate. Y¹ and Y² are each independently hydrogen, fluorine or an alkyl group with 1 to 4 carbons, and are preferably hydrogen, fluorine, methyl or ethyl group. R¹ and R² are each independently hydrogen, fluorine or an alkyl group with 1 to 4 carbons, and are preferably hydrogen, fluorine or methyl group. The letter n is an integer from 1 to 3, and is preferably 1. In particular, the alkylene group represented by (CR¹R²)ₙ in Formula (II) is preferably a methylene group (CH₂) or dimethylmethylene group (C(CH₃)₂). It does not matter if the combinations of Y¹ and Y² and R¹ and R² produce a solid at room temperature as long as the product is liquid when prepared as a nonaqueous electrolyte.

In the fluorinated cyclic carbonate represented by Formula (II), the combinations shown in Table 2 below are preferred as combinations of Y¹, Y² and the alkylene group represented by (CR¹R²)ₙ.

TABLE 2

| Nonaqueous solvent | Y¹ | Y² | Alkylene group |
|---|---|---|---|
| K | H | H | CH₂ |
| L | H | F | CH₂ |
| M | H | CH₃ | CH₂ |
| N | H | C₂H₅ | CH₂ |
| O | F | F | CH₂ |
| P | F | CH₃ | CH₂ |
| Q | F | C₂H₅ | CH₂ |
| R | CH₃ | CH₃ | CH₂ |
| S | CH₃ | C₂H₅ | CH₂ |
| T | C₂H₅ | C₂H₅ | CH₂ |
| U | H | H | C(CH₃)₂ |
| V | F | F | C(CH₃)₂ |
| W | CH₃ | CH₃ | C(CH₃)₂ |
| X | H | H | CH₂CH₂ |
| Y | CH₃ | CH₃ | CH₂CH₂ |
| Z | H | H | C(CH₃)₂CH₂C(CH₃)₂ |

Of these, the 6-membered fluorinated cyclic carbonates with the combinations shown for nonaqueous solvent K, nonaqueous solvent R and nonaqueous solvent U are preferred.

Fluorinated cyclic carbonate (A) is preferably either a 5-membered fluorinated cyclic carbonate represented by Formula (I) or a 6-membered (n=1) fluorinated cyclic carbonate represented by Formula (II), and is more preferably composed solely of a 5-membered cyclic carbonate represented by Formula (I).

An embodiment of the fluorinated phosphazene (B) represented by Formula (III) is explained next. In the fluorinated phosphazene (B) represented by Formula (III), at least one of Z¹ and Z² is a fluorine atom, while the other is independently hydrogen, an alkoxy group with 1 to 4 carbons or a phenoxy group. Preferably, the other is hydrogen, methoxy, ethoxy or phenoxy group.

In the fluorinated phosphazene (B) represented by Formula (III), the number of fluorine atoms bound to the phosphorus of the phosphazene molecule is such that the ratio of the number of fluorine atoms to the number of phosphorus atoms (number of fluorine atoms/number of phosphorus atoms) is 4/3 or more. The upper limit of the ratio of the number of fluorine atoms to the number of phosphorus atoms (number of fluorine atoms/number of phosphorus atoms) is 2, meaning that 2 fluorine atoms are bound to each of all the phosphorus atoms of the phosphazene bonds (P═N). The ratio of the number of fluorine atoms to the number of phosphorus atoms (number of fluorine atoms/number of phosphorus atoms) is preferably 5/3 or more for purposes of suppressing gas production due to carbonate decomposition.

The fluorinated phosphazene (B) represented by Formula (III) may be either chain or cyclic, but preferably forms a cyclic structure from the standpoint of reducing the viscosity of the nonaqueous electrolyte solution. In the fluorinated phosphazene (B) represented by Formula (III), m is an integer from 2 to 10, or preferably from 2 to 5. In the case of a cyclic phosphazene, m is preferably 3 (6-membered ring), while in the case of a chain phosphazene, m is preferably 2. In the case of a chain phosphazene, the P terminus is preferably a C₁₋₄ alkoxy group for example, while the N terminus is preferably a C₁₋₄ dialkylphosphate group for example.

When fluorinated phosphazene (B) is cyclic and m=3 (6-membered ring) in Formula (III), fluorinated phosphazene (B) is preferably at least one selected from the group consisting of the phosphazene represented by Formula (VI) below, the phosphazene represented by Formula (VII) below and the phosphazene represented by Formula (VIII) below:

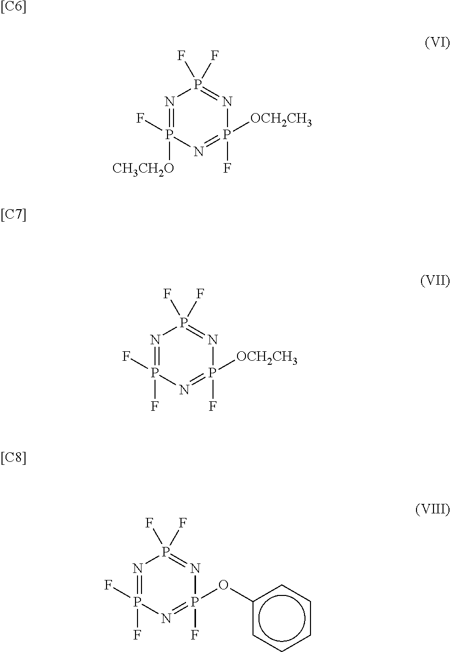

In the nonaqueous solvent of the present embodiment, the content of fluorinated cyclic carbonate (A) as a percentage in the nonaqueous solvent is preferably 5 to 80 mol % while the content of fluorinated phosphazene (B) as a percentage in the nonaqueous solvent is preferably 1 to 20 mol %.

When fluorinated cyclic carbonate (A) has a 5-membered ring structure in particular, it can dissolve and dissociate a lithium salt or other alkali metal salt, contributing ion conductivity to the nonaqueous solvent. If the molar percentage of fluorinated cyclic carbonate (A) in the nonaqueous solvent is less than 5%, the cycle characteristics of the nonaqueous secondary battery are likely to be less. If the percentage exceeds 80%, on the other hand, it will be difficult to suppress gas production in the battery, and the protective coat formed on the negative electrode will be thicker, potentially detracting from the negative electrode characteristics.

As described above, fluorinated phosphazene (B) can suppress gas production due to decomposition of the co-existing fluorinated cyclic carbonate (A), and can also suppress gas production due to decomposition of a non-fluorinated carbonate if such is included. If the molar percentage of fluorinated phosphazene (B) in the nonaqueous solvent is less than 1%, however, its effects will be insufficient. If the percentage exceeds 20%, on the other hand, even if the nonaqueous solvent forms a single phase, it will tend to separate into two phases when the alkali metal salt is dissolved.

The nonaqueous solvent of the present embodiment may also contain multiple other nonaqueous solvents in addition to the aforementioned fluorinated cyclic carbonate (A) and fluorinate phosphazene (B). The mixture fraction of the other nonaqueous solvents is preferably within the range of 0 to 94% as a molar percentage in the total with fluorinated cyclic carbonate (A) and fluorinated phosphazene (B) ((A)+(B)+other nonaqueous solvents). When the content of the other nonaqueous solvents (non-fluorinated carbonates and the like) is increased, it is desirable to increase the content of fluorinated phosphazene (B) to the extent that the electrolyte solution does not separate into two phases.

Examples of other nonaqueous solvents that can be used together with fluorinated cyclic carbonate (A) and fluorinated phosphazene (B) include non-fluorinated cyclic carbonates such as ethylene carbonate (EC), propylene carbonate (PC), butylene carbonate (BC) and the like. A cyclic ester such as γ-butyrolactone (γ-BL), α-methyl-γ-butyrolactone or γ-valerolactone can also be used. The mixture fraction of the cyclic carbonate or cyclic ester is preferably such that the molar percentage in the nonaqueous solvent as a whole is in the range of 10 to 90%. Combining the cyclic carbonate or cyclic ester serves to increase the number of ions transporting charge by dissociation from the alkali metal salt, while stabilizing the protective coat on the negative electrode, thereby improving the cycle characteristics.

A chain carbonate such as dimethyl carbonate (DMC), ethylmethyl carbonate (EMC), diethyl carbonate (DEC), methylpropyl carbonate (MPuC), methylbutyl carbonate (MBC) or methylpentyl carbonate (MPeC) can also be included in the nonaqueous solvent of the present embodiment. Including the chain carbonate serves to lower the viscosity of the nonaqueous solvent, thereby facilitating movement of lithium and other ions. The molar percentage of the chain carbonate in the nonaqueous solvent as a whole is preferably 0 to 80%. When the content of fluorinated phosphazene (B) is 10% or more, the content of the chain carbonate is preferably 60% or more, and the principal component of the chain carbonate is preferably DMC. When the content of fluorinated phosphazene (B) is less than 10%, a chain carbonate having an alkyl group as long as or longer than an ethyl group can be used as the principal component of all the chain carbonates in the solvent. By mixing the chain carbonate having an alkyl group as long as or longer than an ethyl group, it is possible to improve the affinity of the nonaqueous electrolyte solution with a polyolefin separator.

A cyclic carbonate having a C═C unsaturated bond can also be included as another nonaqueous solvent. Examples include vinylene carbonate, vinyl ethylene carbonate, divinyl ethylene carbonate, phenyl ethylene carbonate, diphenyl ethylene carbonate and the like.

A cyclic ester having a C═C unsaturated bond can also be used as another nonaqueous solvent. Specific examples include furanone, 3-methyl-2(5H)-furanone, α-angelica lactone and the like.

A chain carbonate having a C═C unsaturated bond can also be included as another nonaqueous solvent. For example, methylvinyl carbonate, ethylvinyl carbonate, divinyl carbonate, allylmethyl carbonate, allylethyl carbonate, diallyl carbonate, allylphenyl carbonate, diphenyl carbonate or the like can be included.

These nonaqueous solvents having C═C unsaturated bonds can act to suppress excessive decomposition of fluorinated cyclic carbonate (A) in the present embodiment on the negative electrode, so that internal resistance of the nonaqueous secondary battery is not increased. The molar percentage of the nonaqueous solvent having a C═C unsaturated bond in the nonaqueous solvent as a whole is 5% or less, or preferably 2% or less.

[Nonaqueous Electrolyte Solution]

A nonaqueous electrolyte solution of one embodiment of the present invention is prepared by dissolving a lithium salt or other alkali metal salt in the nonaqueous solvent comprising a mixture of the aforementioned fluorinated cyclic carbonate (A) and fluorinated phosphazene (B).

LiPF₆, LiBF₄, LiClO₄, LiN(SO₂CF₃)₂, LiN(SO₂C₂F₅)₂, Li[N(SO₂)₂(CF₂)₂] (wherein the anion forms a 5-membered ring), Li[N(SO₂)₂(CF₂)₃] (wherein the anion forms a 6-membered ring), LiPF₃(CF₃)₃, LiPF₃(C₂F₅)_{3,} LiBF₃(CF₃), LiBF₃(C₂F₅) or LiB(CO₂CO₂)₂ (wherein B(CO₂CO₂)₂ forms two 5-membered rings with B as the shared atom) or the like can be used as the lithium salt.

The concentration of the lithium salt in the nonaqueous electrolyte solution is preferably in the range of 0.6 to 1.8 moles/liter, or more preferably 1.2 to 1.4 moles/liter. By maintaining the lithium salt concentration at a sufficiently high level, it is possible to improve the oxidation resistance of the nonaqueous solvent while reducing the reactivity between the nonaqueous solvent and the positive electrode in a charged state.

A sodium salt, potassium salt, rubidium salt or cesium salt can be used in combination with the lithium salt. Anions of these alkali metal salts can be selected from the anions shown for the lithium salts above. When another alkali metal salt is used in combination with a lithium salt, the molar fraction of the lithium salt as a percentage in the alkali metal salts as a whole is preferably 95% or more. Inclusion of a trace amount of a sodium salt acts against an increase in the internal resistance of the nonaqueous secondary battery in the same way as a nonaqueous solvent having a C═C unsaturated bond.

[Nonaqueous Secondary Battery]

A configuration similar to that of a conventional nonaqueous secondary battery can be adopted for the nonaqueous secondary battery of one embodiment of the present invention so long as it uses the nonaqueous electrolyte solution comprising the nonaqueous solvent of the present invention. The nonaqueous secondary battery of the present embodiment comprises a positive electrode, a negative electrode and a separator for example.

The positive electrode comprises a positive electrode current collector and a positive electrode active material layer for example.

A porous or non-porous conductive substrate can be used as the positive electrode current collector. Of these, a porous conductive substrate is preferred from the standpoint of permeability of the nonaqueous electrolyte solution in an electrode assembly consisting of a positive electrode, a negative electrode and a separator. The porous conductive substrate may be in the form of a mesh, net, punching sheet, lath body, porous body, foam, fibrous compact (such as nonwoven fabric) or the like. Examples of nonporous conductive substrates include foils, sheets, films and the like. The material of the conductive substrate may be a metal material such as stainless steel, titanium, aluminum, aluminum alloy or the like for example. The thickness of the conductive substrate is not particularly limited, but is preferably about 5 to 50 μm.

The positive electrode active material layer contains a positive electrode active material, and also contains a conductive material, a binder and the like as necessary, and is preferably fanned on one or both surfaces in the direction of thickness of the positive electrode current collector.

Examples of positive electrode active materials include lithium transition metal oxides such as lithium cobaltate, lithium nickelate, lithium manganate and lithium iron phosphate and conductive polymer compounds such as polyacetylene, polypyrrole and polythiophene. A carbon material such as active carbon, carbon black, non-graphitizable carbon, artificial graphite, natural graphite, carbon nanotubes, fullerenes or the like can also be used as the positive electrode active material.

These positive electrode active materials do not behave in the same way during charge and discharge. For example, carbon materials and conductive polymer compounds can take up anions from the electrolyte solution into themselves during charge, and release those internal anions into the electrolyte solution during discharge. On the other hand, lithium transition metal oxides release their own internal lithium ions into the electrolyte solution during charge, and take up lithium ions from the electrolyte solution into themselves during discharge.

The conductive agent can be one commonly used in the field, and examples include natural graphite, artificial graphite and other graphites, acetylene black, ketjen black, channel black, furnace black, lamp black, thermal black and other carbon blacks, carbon fibers, metal fibers and other conductive fibers, aluminum and other metal powders, zinc oxide whiskers, conductive potassium titanate whiskers and other conductive whiskers, titanium oxide and other conductive metal oxides, and phenylene conductive bodies and other organic conductive materials and the like. One conductive material can be used alone, or two or more may be used in combination.

The binder can be one commonly used in the field, and examples include polyvinylidene fluoride, polytetrafluoroethylene, polyethylene, polypropylene, aramid resin, polyamide, polyimide, polyamidimide, polyacrylonitrile, polyacrylic acid, polymethyl acrylate, polyethyl acrylate, polyhexyl acrylate, polymethacrylic acid polymethyl methacrylate, polyethyl methacrylate, polyhexyl methacrylate, polyvinyl acetate, polyvinyl pyrrolidone, polyether, polyether sulfone, hexafluoropolypropylene, styrene-butadiene rubber, modified acrylic rubber, carboxymethyl cellulose and the like.

The positive electrode active material layer can be formed by coating a positive electrode mixture slurry on the surface of the positive electrode current collector, drying, and rolling. The thickness of the positive electrode active material layer can be selected appropriately according to the various conditions and the like, but is preferably about 50 to 100 μm.

The positive electrode mixture slurry can be prepared by dissolving the positive electrode active material together with a conductive material, binder and the like as necessary in an organic solvent. Dimethyl formamide, dimethyl acetamide, methyl formamide, N-methyl-2-pyrrolidone, dimethylamine, acetone, cyclohexanone or the like can be used as the organic solvent.

The negative electrode comprises a negative electrode current collector and a negative electrode active material layer for example.

A porous or nonporous conductive substrate can be used as the negative electrode current collector. Of these, a porous conductive substrate is preferred from the standpoint of permeability of the nonaqueous electrolyte solution in an electrode assembly consisting of a positive electrode, a negative electrode and a separator. The porous conductive substrate may be in the form of a mesh, net, punching sheet, lath body, porous body, foam, fibrous compact (such as nonwoven fabric) or the like. Examples of nonporous conductive substrates include foils, sheets, films and the like. The material of the conductive substrate may be a metal material such as stainless steel, nickel, copper, copper alloy or the like for example. The thickness of the conductive substrate is not particularly limited, but is preferably about 5 to 50 μm.

The negative electrode active material layer contains the negative electrode active material, and also contains a viscosity improver, a conductive material, a binder and the like as necessary, and is preferably formed on one or both surfaces in the direction of thickness of the negative electrode current collector.

Examples of negative electrode active materials include lithium metal, carbon materials, conductive polymer compounds, lithium transition metal oxides, metal oxides that react with lithium and decompose into lithium oxide and metal, and alloy-based negative electrode active materials and the like for example. The alloy-based negative electrode active material is a substance that stores lithium inside itself by alloying with lithium at low negative electrode potential, and reversibly releases lithium.

Examples of carbon materials include carbon black, non-graphitizable carbon, artificial and natural carbon covered on the surface with amorphous carbonaceous material, and carbon nanotubes, fullerenes and the like. Examples of conductive polymer compounds include polyacetylene, polyparaphenylene and the like. Examples of lithium transition metal oxides include Li₄Ti₅O₁₂ and the like. Examples of metal oxides that react with lithium and break down into lithium oxide and metal include CoO, NiO, MnO, Fe₂O₃ and the like.

Examples of alloy-based negative electrode active materials include metals capable of alloying with lithium, and substances containing oxygen and metals capable of alloying with lithium. Specific examples of metals capable of alloying with lithium include Ag, Au, Zn, Al, Ga, In, Si, Ge, Sn, Pb, Bi and the like. Specific examples of substances containing oxygen and metals capable of alloying with lithium include Si oxides, Sn oxides and the like.

Of these negative electrode active materials, a negative electrode active material that stores lithium ions when charged and releases lithium ions when discharged is preferred. Specifically, a carbon material or alloy-based negative electrode active material is preferred. Using such a negative electrode active material, a protective coat is formed by reductive decomposition of the electrolyte solution on the surface of the negative electrode during initial charging. This reduces reactivity between the electrolyte solution and the negative electrode in a charged state, thereby improving the cycle characteristics.

Of the carbon materials and alloy-based negative electrode active materials, the alloy-based negative electrode active material is especially preferred, and it is particularly desirable to use a substance containing oxygen and an element capable of alloying with lithium, or in other words an oxide of Si, Sn or the like. A protective coat of lithium oxide (Li₂O) is formed on the surface with these oxides, further improving the cycle characteristics.

The negative electrode active material layer can be formed by coating a negative electrode mixture slurry on the surface of the negative electrode current collector, drying, and rolling. The thickness of the negative electrode active material layer can be selected appropriately according to the various conditions, but is preferably about 50 to 100 μm. The negative electrode mixture slurry can be prepared by dissolving or dispersing the negative electrode active material together with a conductive material, binder, viscosity improver and the like as necessary in an organic solvent or water. The conductive material, binder and organic solvent can be the same as those used in preparing the positive electrode mixture slurry. The viscosity improver can be carboxymethyl cellulose or the like for example.

When lithium metal is used as the negative electrode active material, the negative electrode active material layer can be formed for example by crimping lithium metal foil to the negative electrode current collector. When the alloy-based negative electrode active material is used as the negative electrode active material, the negative electrode active material layer can be formed by vacuum deposition, sputtering, chemical vapor deposition or the like.

The separator is interposed between the positive electrode and negative electrode, insulating the positive electrode from the negative electrode. A sheet or film having the designated ion permeability, mechanical strength, insulating properties and the like is used. Specific examples of separators include microporous membranes, woven cloth, nonwoven cloth and other porous sheets and films. A microporous membrane may be a single layer membrane or multilayer membrane (composite membrane). The separator may consist of 2 or more superimposed layers of microporous membrane, woven cloth, nonwoven cloth or the like as necessary.

The separator is prepared from various resin materials. Of the resin materials, a polyolefin such as polyethylene or polypropylene is preferred from the standpoint of durability, shutdown function and stability of the battery. The shutdown function here means the function of blocking through holes during abnormal heat generation in the battery, thereby suppressing ion permeation and shutting down the battery reaction. The thickness of the separator is ordinarily 5 to 300 μm, or preferably 10 to 40 μm, or more preferably 10 to 20 μm. The porosity of the separator is preferably 30 to 70%, or more preferably 35 to 60%. The porosity here is the ratio of the total volume of the pores in the separator to the apparent volume of the separator.

In the nonaqueous secondary battery of the present embodiment, an electrode assembly prepared by interposing a separator between the positive and negative electrodes can be of either the laminated or coiled type. The nonaqueous secondary battery of the present embodiment can also be prepared in various forms. Examples of possible forms include oblong batteries, cylindrical batteries, coin-shaped batteries, metal laminate film batteries and the like.

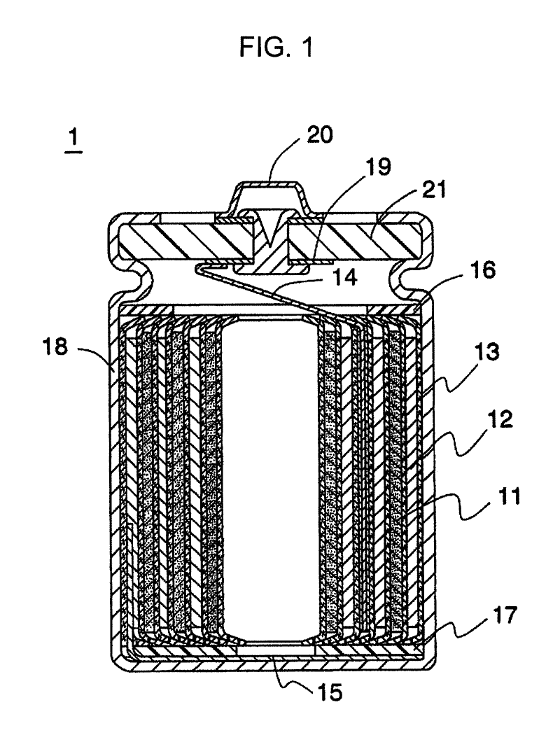

FIG. 1 is a vertical cross-sectional view illustrating the configuration of cylindrical nonaqueous secondary battery 1 according to one embodiment of the present invention. Nonaqueous secondary battery 1 is a cylindrical battery comprising positive electrode 11, negative electrode 12, separator 13, positive electrode lead 14, negative electrode lead 15, upper insulating plate 16, lower insulating plate 17, battery case 18, seal plate 19, positive electrode terminal 20 and the electrolyte solution of the present invention (not shown).

Positive electrode 11 and negative electrode 12 are coiled in spiral form with separator 13 between the two to prepare a coiled electrode assembly. One end of positive electrode lead 14 is connected to positive electrode 11, and the other is connected to seal plate 19. Positive electrode lead 14 can be made of aluminum for example. One end of negative electrode lead 15 is connected to negative electrode 12, and the other is connected to the bottom of battery case 18. Negative electrode lead 15 can be made of nickel for example.

Battery case 18 is a cylindrical container with a bottom, having one end open and the other forming the bottom in the direction of length. In this embodiment, battery case 18 functions as the negative electrode terminal. Upper insulating plate 16 and lower insulating plate 17 are resin parts mounted on both ends of the coiled electrode assembly in the direction of length to insulate the coiled electrode assembly from the other parts. Battery case 18 can be made of iron for example. The inside of battery case 18 can be plated with nickel for example. Seal plate 19 is provided with positive electrode terminal 20.

Cylindrical nonaqueous secondary battery 1 can be prepared as follows for example. First, the ends of the positive electrode lead and negative electrode lead are connected to their respective designated locations on the coiled electrode assembly. Next, upper insulating plate 16 and lower insulating plate 17 are mounted, respectively, on the upper and lower ends of the coiled electrode assembly, which is then housed in battery case 18.

The other end of positive electrode lead 14 is connected to seal plate 19. The other end of negative electrode lead 15 is connected to the bottom of battery case 18. Next, the electrolyte solution of the present invention is injected into battery case 18. Seal plate 19 is mounted on the opening of battery case 18, and the opening end of battery case 18 is crimped inward to fix seal plate 19 and seal battery case 18. Nonaqueous secondary battery 1 is obtained in this way. Resin gasket 21 is positioned between battery case 18 and seal plate 19.

### EXAMPLES

The present invention is explained in more detail below by means of examples and comparative examples.

### Example 1

### Investigation of Gas Generation During High-Temperature Storage using Various Fluorinated Cyclic Carbonates

(1) Preparation of Test Electrode

98 parts by weight of artificial graphite powder (Hitachi Chemical) was mixed with 1 part by weight of modified styrene-butadiene latex (binder) and 1 part by weight of carboxymethyl cellulose (viscosity improver). The resulting mixture was dispersed in water to prepare a mixture slurry. This mixture slurry was coated on the surface of a 10 μm-thick copper foil, and dried and rolled to form a 70 μm-thick active material layer on the copper foil surface and obtain an active material sheet. This active material sheet was cut out into a 35 mm×35 mm size, and ultrasound welded to a copper plate with a lead to prepare a test electrode.

(2) Preparation of Counter Electrode

300 μm-thick lithium foil was crimped to a 35 mm×35 mm copper plate with a welded lead to prepare a counter electrode.

(3) Preparation of Nonaqueous Electrolyte Solution

A nonaqueous electrolyte solution was obtained by dissolving 152 g of LiPF₆ in 1 L of dimethyl carbonate (DMC) in an argon atmosphere glove box.

(4) Preparation of Electrode Containing Impurities

The aforementioned test electrode and counter electrode were placed opposite each other in a PFA resin container in an argon atmosphere, and the prepared electrolyte solution was poured in. This was used as an electrochemical cell.

Anode current was supplied at a current density of 0.7 mA to the counter electrode, so that the amount of conducted current was 330 mAh/g of the graphite powder on the test electrode. Next, anode current of the same current density was supplied to the test electrode, and continued until the voltage of the electrochemical cell was 1.5 V. This operation was repeated three times. After completion of the third supply of anode current to the test electrode, the open circuit voltage was about 0.8 V.

The test electrode was removed from the electrochemical cell, and the active material sheet was separated from the copper plate. The active material sheet was washed twice with about 100 mL of DMC, and dried under reduced pressure for 5 minutes. The sheet thus prepared was used as an electrode containing impurities.

(5) Preparation of Nonaqueous Solvents

DMC, the fluorinated cyclic carbonates A through Z shown in Tables 1 and 2, and the fluorinated phosphazene represented by Formula (VII) were mixed at a molar ratio of 80/10/10 to prepare the nonaqueous solvents A1 through Z1 shown in Table 3 below. The nonaqueous solvent of A1 is a solvent using the nonaqueous solvent A of Table 1 as the fluorinated cyclic carbonate. A1 through Z1 are given as nonaqueous solvents of examples of the present invention.

DMC, fluorinated cyclic carbonate A of Table 1 and the hexamethoxy cyclotriphosphazene represented by Formula (IX) below were mixed at a molar ratio of 80/10/10 to prepare nonaqueous solvent a1. This a1 is given as the nonaqueous solvent of the comparative example.

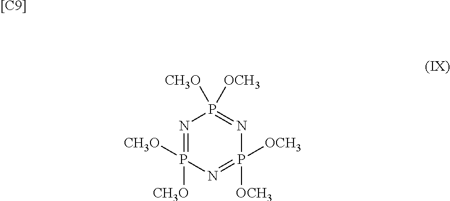

(6) Reaction of Nonaqueous Solvent with Impurities of Electrode

1 g of each of the nonaqueous solvents shown in Table 3 was placed in an aluminum laminate bag with the electrode containing impurities prepared in (4) above, and sealed. These were stored for 1 hour at 150° C. During storage, impurities such as lithium methoxide (CH₃OLi) on the electrode dissolved into the nonaqueous solvent, breaking down the non-fluorinated carbonate DMC and producing gas. Gas was also produced when the fluorinated cyclic carbonates A through Z were further attacked by dissolved impurities from the electrode and DMC decomposition products. The amount of gas generated in the laminate bags was measured by submerging the laminate bags in water set to a temperature of 20° C. and by measuring buoyancy changes after storage at 150° C.

(7) Results

Table 3 shows the results of the investigation of gas production during high-temperature storage using nonaqueous solvents prepared by mixing the various fluorinated cyclic carbonates.

TABLE 3

| Nonaqueous solvent | Gas production, mL |
|---|---|
| A1 | 2.3 |
| B1 | 2.8 |
| C1 | 2.4 |
| D1 | 2.5 |
| E1 | 2.6 |
| F1 | 2.7 |
| G1 | 2.6 |
| H1 | 2.1 |
| I1 | 2.4 |
| J1 | 2.7 |
| K1 | 3.4 |
| L1 | 4.1 |
| M1 | 3.8 |
| N1 | 4.1 |
| O1 | 3.9 |
| P1 | 3.8 |
| Q1 | 4.0 |
| R1 | 3.3 |
| S1 | 3.7 |
| T1 | 4.0 |
| U1 | 3.2 |
| V1 | 3.7 |
| W1 | 4.1 |
| X1 | 4.9 |
| Y1 | 4.4 |
| Z1 | 5.4 |
| a1 | 11.5 |

The following can be seen from Table 3. (1) The amount of gas produced is smaller in the case of nonaqueous solvent A1 using the fluorinated phosphazene of the present invention than in the case of nonaqueous solvent a1 of the comparative example. (2) Comparing the sizes of the fluorinated cyclic carbonate rings, it appears that the larger the ring structure, the more gas is produced. (3) Of the 5-membered ring fluorinated carbonates, the amount of gas produced was smaller in the case of nonaqueous solvents A1 (nonaqueous solvent A in Table 1) and H1 (nonaqueous solvent H in Table 1). (4) Of the 6-membered ring fluorinated carbonates, the amount of gas produced was smaller in the case of nonaqueous solvents K1 (nonaqueous solvent K in Table 2), R1 (nonaqueous solvent R in Table 2) and U1 (nonaqueous solvent U in Table 2).

The reason why more gas was produced in the case of nonaqueous solvent a1 in the comparative example is explained as follows. It is thought that more gas was produced because the phosphazene used in the comparative example could not suppress dissolution of impurities from the electrode, thereby causing to produce gas by decomposing DMC, and dissolved impurities from the electrodes and DMC decomposition products further attacked the fluorinated cyclic carbonate, thereby producing more gas.

### Example 2

### Investigation of Gas Production During High-Temperature Storage using Various Fluorinated Cyclic Phosphazenes

(1) Preparation of Fluorinated Cyclic Phosphazenes

The hexamethoxy cyclotriphosphazene (b0) represented by Formula (IX) above was prepared, along with fluoro-pentamethoxy cyclotriphosphazene (b1), difluoro-tetramethoxy cyclotriphosphazene (b2), trifluoro-trimethoxy cyclotriphosphazene (b3), tetrafluoro-dimethoxy cyclotriphosphazene (B4) and pentafluoro-methoxy cyclotriphosphazene (B5), in which 1 to 5 methoxy groups in the b0 molecule were respectively replaced with 1 to 5 fluorine atoms. The trifluoro compound is a mixture of a compound having two F atoms bound to one P atom and one F atom bound to the other P atom with a compound having one F atom bound to each of three P atoms. The tetrafluoro compound is a mixture of a compound having two F atoms bound to one P atom and two F atoms bound to the other P atom with a compound having two F atoms bound to one P atom and one F atom bound to each of the other two P atoms.

The fluorinated cyclic phosphazene (B6) represented by Formula (VII) was also prepared, along with the phosphazenes in which the ethoxy group in the B6 molecule was replaced with a propoxy group (B7), butoxy group (B8), and pentoxy group (B9).

The fluorinated cyclic phosphazene (B10) represented by Formula (VI) and the fluorinated cyclic phosphazene (B11) represented by Formula (VIII) were also prepared.

(2) Preparation of Nonaqueous Solvents

One was selected from the fluorinated cyclic phosphazenes b0 through b3 and B4 through B10 prepared above. DMC, the fluorinated cyclic carbonate represented by Formula (V) (H of Table 1), and the selected fluorinated cyclic phosphazene were mixed at a molar ratio of 80/10/10 to prepare nonaqueous solvents.

(3) Reaction Between Nonaqueous Solvents and Electrode Impurities

The nonaqueous solvents prepared above were stored for 1 hour at 150° C. as in Example 1 with the electrode having impurities. The gas produced during storage was measured as in Example 1.

(4) Results

FIG. 4 shows the results of an investigation of gas production during high-temperature storage using nonaqueous solvents prepared with the various fluorinated cyclic phosphazenes.

TABLE 4

| Fluorinated cyclic phosphazene | |
|---|---|
| used in nonaqueous solvent | Gas production, mL |
| b0 | 10.9 |
| b1 | 8.1 |
| b2 | 7.3 |
| b3 | 6.7 |
| B4 | 2.8 |
| B5 | 2.3 |
| B6 | 2.1 |
| B7 | 2.4 |
| B8 | 2.5 |
| B9 | 2.7 |
| B10 | 2.5 |
| B11 | 1.9 |

The following can be seen from Table 4. (1) The greater the number of fluorine atoms in the fluorinated cyclic phosphazene, the less gas was produced. (2) Gas production was suppressed more effectively when the ratio of fluorine atoms bound to the phosphorus of the phosphazene (number of fluorine atoms/number of phosphorus atoms) was 4/3 or more (B4 through B11) than when it was 3/3 or less (b0 through b3). (3) Gas production was particularly reduced when the alkoxy group was a methoxy (B5), ethoxy (B6) or phenoxy (B11) group.

### Example 3

### Investigation of Gas Production During High-Temperature Storage using Various Fluorinated Chain Phosphazenes

(1) Preparation of Fluorinated Chain Phosphazenes

The fluorinated chain phosphazene represented by Formula (X) below was prepared. The phosphazenes with n values of 1 through 10 (corresponding to m=2 through 11 in the fluorinated phosphazene represented by Formula (III)) were prepared.

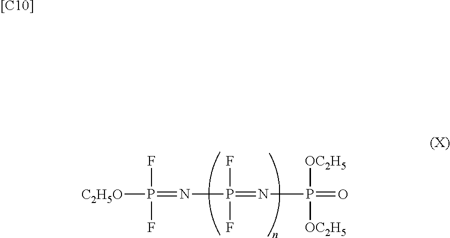

The n=1 (m=2) fluorinated chain phosphazene was called C1, the n=2 (m=3) fluorinated chain phosphazene C2, the n=4 (m=5) fluorinated chain phosphazene C3, the n=6 (m=7) fluorinated chain phosphazene C4, the n=8 (m=9) fluorinated chain phosphazene C5, and the n=10 (m=11) fluorinated chain phosphazene c1.

(2) Preparation of Nonaqueous Solvents

One was selected from the fluorinated chain phosphazenes C1 through C5 and the fluorinated chain phosphazene c1 prepared above. DMC, the fluorinated cyclic carbonate represented by Formula (V) (H in Table 1) and the selected fluorinated chain phosphazene were mixed in the molar ratio of 85/10/5 to prepare nonaqueous solvents.

(3) Reaction of Nonaqueous Solvent with Electrode Impurities

The nonaqueous solvents prepared above were stored for 1 hour at 150° C. as in Example 1 with the electrode having impurities. The gas produced during storage was measured as in Example 1.

(4) Results

Table 5 shows the results of an investigation of gas production during high-temperature storage using nonaqueous solvents prepared with the various fluorinated chain phosphazenes.

TABLE 5

| Fluorinated chain phosphazene | |
|---|---|
| used in nonaqueous solvent | Gas production, mL |
| C1 | 2.5 |
| C2 | 2.7 |
| C3 | 2.8 |
| C4 | 3.7 |
| C5 | 4.6 |
| c1 | 6.8 |

The following can be seen from Table 5. (1) The shorter the phosphazene chain in the fluorinated chain phosphazene (the smaller the value of m in Formula III)), the more gas production can be suppressed. (2) Gas production is much greater when the number (m) of P═N bonds in the phosphazene molecule is 11 or more.

### Example 4

### Assembly of Nonaqueous Secondary Battery and Measurement of Various Battery Characteristics

(1) Preparation of Positive Electrode

93 parts by weight of LiCoO₂ powder (Nichia Corp.) as the positive electrode active material, 3 parts by weight of acetylene black as the conductive material and 4 parts by weight of vinylidene fluoride-hexafluoropropylene copolymer as the binder were mixed, and the resulting mixture was dispersed in anhydrous N-methyl-2-pyrrolidone to prepare a positive electrode mixture paste. A positive electrode sheet was prepared by coating this positive electrode mixture paste on the surface of a 15 μm-thick aluminum foil, and drying and rolling to form a 65 μm-thick positive electrode active material layer. The positive electrode sheet was cut out into a 35 mm×35 mm size, and ultrasound welded to an aluminum plate with a lead to obtain a positive electrode.

(2) Preparation of Negative Electrode

A negative electrode having artificial graphite powder as the active material was prepared in the same way as the test electrode of Example 1.

(3) Preparation of Nonaqueous Electrolyte Solutions

Dimethyl carbonate (DMC), ethylene carbonate (EC), the fluorinated cyclic carbonate represented by Formula (V) as fluorinated cyclic carbonate (A) and the fluorinated cyclic phosphazene represented by Formula (VII) as fluorinated phosphazene (B) were mixed in the proportions (molar ratios) shown in Table 6 below for the nonaqueous solvent. LiPF₆ was dissolved in the proportion of 1 mole per 1 liter of each of these mixed solvents to prepare nonaqueous electrolyte solutions D1 through D15.

TABLE 6

| | | | Fluorinated | Fluorinated |
|---|---|---|---|---|
| | DMC | EC | cyclic carbonate | phosphazene |
| D1 | 75 | 12 | 3 | 10 |
| D2 | 84.5 | 10 | 5 | 0.5 |
| D3 | 84 | 10 | 5 | 1 |
| D4 | 82 | 10 | 5 | 3 |
| D5 | 80 | 10 | 5 | 5 |
| D6 | 75 | 10 | 5 | 10 |
| D7 | 65 | 10 | 5 | 20 |
| D8 | 60 | 10 | 5 | 25 |
| D9 | 85 | — | 10 | 5 |
| D10 | 75 | — | 20 | 5 |
| D11 | 65 | — | 30 | 5 |
| D12 | 45 | — | 50 | 5 |
| D13 | 35 | — | 70 | 5 |
| D14 | 15 | — | 80 | 5 |
| D15 | 5 | — | 90 | 5 |

(4) Assembly of Battery

An electrode assembly was prepared by interposing polyethylene separators between the positive and negative electrodes and fixing the positive and negative electrodes with tape to form a unit. The electrode assembly was vacuum dried for 1 hour at 85° C. Next, the electrode assembly was housed in a tubular aluminum laminate bag with two open ends. The positive electrode lead and negative electrode lead were threaded outside through one opening in the aluminum laminate bag, and this opening was sealed by welding. The prepared electrolyte solutions D1 through D15 were then dripped into the aluminum laminate bags through the other openings. The insides of the aluminum laminate bags were deaerated for 5 seconds at 10 mmHg, and the other openings were sealed by welding. Batteries were prepared in this way.

Using the batteries prepared above, charging was performed at 20° C. at a constant current of 3.5 mA up to a battery voltage of 4.2 V. This was followed by discharge at the same current down to a battery voltage of 3.0 V. The discharged capacity after 5 repetitions of this charge-discharge cycle was about 36 mAh.

(5) Measurement of Battery Load Characteristics

The batteries were charged at 20° C. at a constant current of 3.5 mA to a voltage of 4.2 V. They were then discharged at a constant current of 7 mA to 3.0 V. The discharged capacity here was 0.2 C capacity.

After 0.2 C capacity was determined, the batteries were discharged at a constant current of 0.35 mA to 3.0 V, and then charged to 4.2 V. The batteries were then discharged at a constant current of 35 mA to a voltage of 3.0 V. The discharged capacity here was 1 C capacity.

The load characteristics of the battery were determined by means of the ratio of 1 C capacity/0.2 C capacity.

(6) Battery Cycle Characteristics

17.5 mA of constant current was supplied to 4.2 V at 20° C., and the battery was then maintained at the same voltage. The total charge time of the battery was set to 2.5 hours. The battery was then discharged to a voltage of 3.0 V at a constant current of 17.5 mA.

This charge and discharge cycle was repeated, and the number of cycles at which the discharged capacity of the battery was 80% of that at the first cycle was evaluated as a cycle characteristic.

(7) Battery High-Temperature Storage Characteristics

The battery was charged to 4.2 V at a constant current of 3.5 mA at 20° C. It was then maintained at that voltage for 12 hours, and open circuit voltage of 4.198 V or more was confirmed. The battery thus charged was left for 24 hours in an environment of 85° C.

The high-temperature storage characteristics of the battery were evaluated in terms of the amount of gas collected from inside the battery after it had cooled to 20° C.

The results are shown in Table 7.

TABLE 7

| | Load charac- | Cycle charac- | High-temperature storage charac- |
|---|---|---|---|
| | teristics | teristics | teristics (gas production, mL) |
| D1 | 0.94 | 264 | 0.09 |
| D2 | 0.96 | 368 | 0.22 |
| D3 | 0.96 | 360 | 0.13 |
| D4 | 0.95 | 349 | 0.12 |
| D5 | 0.94 | 324 | 0.12 |
| D6 | 0.92 | 305 | 0.10 |
| D7 | 0.85 | 283 | 0.08 |
| D8 | 0.77 | 244 | 0.05 |
| D9 | 0.95 | 311 | 0.10 |
| D10 | 0.93 | 321 | 0.08 |
| D11 | 0.91 | 338 | 0.06 |
| D12 | 0.88 | 331 | 0.06 |
| D13 | 0.84 | 327 | 0.09 |
| D14 | 0.80 | 309 | 0.13 |
| D15 | 0.75 | 282 | 0.37 |

The following can be seen from Table 7. Adequate characteristics are provided by the nonaqueous secondary batteries with all of the compositions, but there are optimal contents for the respective components for obtaining satisfactory load characteristics, cycle characteristics and high-temperature storage characteristics. Namely, good battery characteristics can be obtained if (1) fluorinated cyclic carbonate (A) is in the range of 5 to 80 mol % and (2) fluorinated phosphazene (B) is in the range of 1 to 20 mol %.

As explained above, one aspect of the present invention is a nonaqueous solvent for a nonaqueous secondary battery, comprising: at least one fluorinated cyclic carbonate (A) selected from the group consisting of a fluorinated cyclic carbonate represented by Formula (I) below and a fluorinated cyclic carbonate represented by Formula (II) below; and a fluorinated phosphazene (B) represented by Formula (III) below.

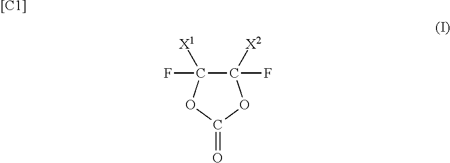

(wherein F represents fluorine, and X¹ and X² each independently represent hydrogen, fluorine or a C₁₋₄ alkyl group).

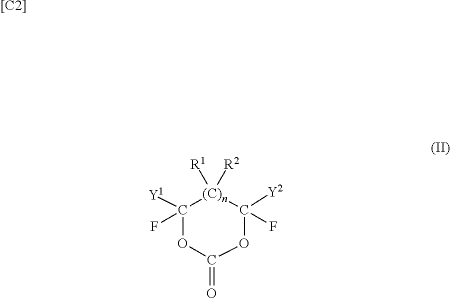

(wherein F represents fluorine, Y¹ and Y² each independently represent hydrogen, fluorine or a C₁₋₄ alkyl group, R¹ and R² each independently represent hydrogen, fluorine or a C₁₋₄ alkyl group, and n is an integer from 1 to 3).

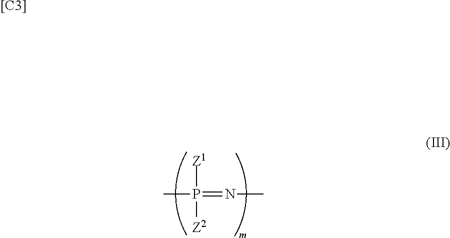

(wherein P represents phosphorus, N represents nitrogen, at least one of Z¹ and Z² represents fluorine while the other one of Z¹ and Z² independently represents hydrogen, a C₁₋₄ alkoxy group or a phenoxy group, and m is an integer from 2 to 10; a ratio of the number of fluorine atoms to the number of phosphorus atoms in Formula (III) [number of fluorine atoms/number of phosphorus atoms] is 4/3 or more; and the fluorinated phosphazene represented by Formula (III) may be either chain or cyclic).

That is, the nonaqueous solvent of the present invention contains fluorinated cyclic carbonate (A) having at least one fluorine atom in each of two specific locations in the molecule, and fluorinated phosphazene (B) having at least one fluorine atom bound to a phosphorus atom in the phosphazene molecule and a specific ratio or greater of the number of fluorine atoms to the number of phosphorus atoms.

With this configuration, because fluorinated cyclic carbonate (A) has a structure in which at least one fluorine atom is substituted for hydrogen bound to carbon at each of two specific locations in the molecule, it can form a good protective coat by reductive decomposition on the negative electrode, thereby improving the cycle characteristics of the nonaqueous secondary battery. This fluorinated cyclic carbonate (A) is also capable of controlling reactivity with the positive electrode in a charged state even at high temperatures.

Moreover, because fluorinated phosphazene (B) also present in the nonaqueous solvent has the ratio of fluorine atoms bound to phosphorus atoms in the phosphazene molecule (number of fluorine atoms/number of phosphorus atoms) being 4/3 or more, even when non-fluorinated carbonates such as EC, DMC and EMC are included, the decomposition products produced by these carbonates on the electrode (such as alkyl cations, alkoxide cations and other organic ions) are less likely to dissolve in the nonaqueous solvent, and decomposition of non-fluorinated carbonates can be effectively reduced, as shown in the Example above. As a result, gas production due to decomposition of non-fluorinated carbonates is suppressed. At the same time, because attacks on fluorinated cyclic carbonate (A) by organic ions are also reduced, less gas is produced by decomposition of fluorinated cyclic carbonate (A). Less gas is produced within the nonaqueous secondary battery as a result. Furthermore, because fluorinated phosphazene (B) has a high ratio of the number of fluorine atoms to the number of phosphorus atoms in the molecule, the fluorinated phosphazene has low viscosity, and thus, a nonaqueous electrolyte solution with low viscosity and high ion conductivity can be obtained.

With the nonaqueous solvent of the present invention and the nonaqueous electrolyte solution using it, stability of the nonaqueous electrolyte solution at high temperatures can be enhanced. It is also possible to obtain a secondary battery with less gas production at high temperatures while exploiting the excellent cycle characteristics provided by the fluorinated cyclic carbonate forming a protective coat on the negative electrode.

### INDUSTRIAL APPLICABILITY

Because the nonaqueous solvent of the present invention is a mixture of a fluorinated cyclic carbonate having at least one fluorine atom substituted for hydrogen bound to carbon at each of two specific locations in the molecule and a fluorinated phosphazene having at least one fluorine bound to the phosphorus of the phosphazene molecule and the ratio of fluorine atoms to phosphorus atoms being a specific value or higher, the cycle characteristics of the nonaqueous secondary battery are improved, and gas production within the battery is suppressed.

The nonaqueous secondary battery of the present invention can be used for applications similar to those of conventional nonaqueous secondary batteries, and is particularly useful as a power source for personal computers, cell phones, mobile devices, portable digital assistants (PDAs), video cameras, portable gaming devices and other portable electronic devices. It is also expected to be useful as a secondary battery to assist in driving the electrical motors of hybrid electric cars, electric cars, fuel cell automobiles and the like, as a drive power source in electric tools, vacuum cleaners, robots and the like, and as a power source in plug-in HEVs and the like.

1. A nonaqueous solvent for a nonaqueous secondary battery, comprising:
at least one fluorinated cyclic carbonate (A) selected from the group consisting of a fluorinated cyclic carbonate represented by Formula (I) below and a fluorinated cyclic carbonate represented by Formula (II) below; and
a fluorinated phosphazene (B) represented by Formula (III) below: 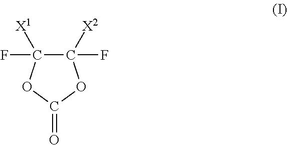
(wherein F represents fluorine, and X¹ and X² each independently represent hydrogen, fluorine or a C₁₋₄ alkyl group), 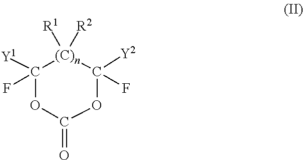
(wherein F represents fluorine, Y¹ and Y² each independently represent hydrogen, fluorine or a C₁₋₄ alkyl group, R¹ and R² each independently represent hydrogen, fluorine or a C₁₋₄ alkyl group, and n is an integer from 1 to 3), 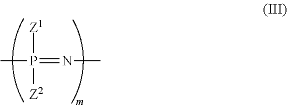
(wherein P represents phosphorus, N represents nitrogen, at least one of Z¹ and Z² represents fluorine while the other one of Z¹ and Z² independently represents hydrogen, a C₁₋₄ alkoxy group or a phenoxy group, and m is an integer from 2 to 10; a ratio of the number of fluorine atoms to the number of phosphorus atoms in Formula (III) [number of fluorine atoms/number of phosphorus atoms] is 4/3 or more; and the fluorinated phosphazene represented by Formula (III) may be either chain or cyclic).

2. The nonaqueous solvent according to claim 1, wherein said fluorinated cyclic carbonate (A) is the fluorinated cyclic carbonate represented by Formula (1), and is either a fluorinated cyclic carbonate represented by Formula (IV) below or a fluorinated cyclic carbonate represented by Formula (V) below.

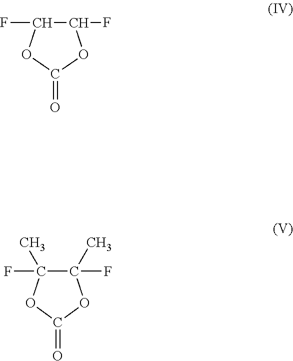

3. The nonaqueous solvent according to claim 1, wherein said fluorinated cyclic carbonate (A) is the fluorinated cyclic carbonated represented by Formula (11), in which n is 1.

4. The nonaqueous solvent according to claim 1, wherein said fluorinated phosphazene (B) is a fluorinated cyclic phosphazene, and m is 3 in Formula (III).

5. The nonaqueous solvent according to claim 4, wherein said fluorinated phosphazene (B) is at least one selected from the group consisting of a fluorinated cyclic phosphazene represented by Formula (VI) below, a fluorinated cyclic phosphazene represented by Formula (VII) below and a fluorinated cyclic phosphazene represented by Formula (VIII) below.

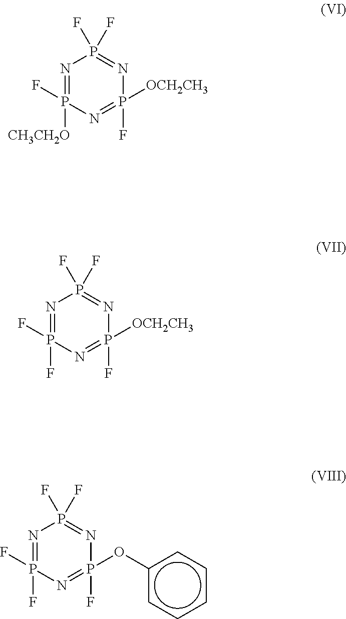

6. The nonaqueous solvent according to claim 1, wherein a content of said fluorinated cyclic carbonate (A) in the nonaqueous solvent is 5 to 80 mol %, and a content of said fluorinated phosphazene (B) in the nonaqueous solvent is 1 to 20 mol %.

7. A nonaqueous electrolyte solution for a nonaqueous secondary battery, wherein an ion-dissociating alkali metal salt is dissolved as an electrolyte in the nonaqueous solvent according to claim 1.

8. A nonaqueous secondary battery, comprising:
a negative electrode and a positive electrode capable of a reversible electrochemical reaction with alkali metal ions; and
the nonaqueous electrolyte solution according to claim 7.
